(19) United States
(12) Patent Application Publication
(10) Pub. No.: US 2025/0286098 A1
(43) Pub. Date: Sep. 11, 2025

(54) MANUFACTURING ARRANGEMENT AND METHOD FOR A FUEL CELL STACK

(71) Applicant: POWERCELL SWEDEN AB, 418 34 Göteborg (SE)

(72) Inventors: Lars Gustaf ARELL, Stenungsund (SE); Johan FLINK, Göteborg (SE); Thomas LYDHIG, Göteborg (SE)

(73) Assignee: POWERCELL SWEDEN AB, 418 34 Göteborg (SE)

(21) Appl. No.: 19/218,863

(22) Filed: May 27, 2025

Related U.S. Application Data
(62) Division of application No. 17/916,830, filed on Oct. 4, 2022.

(30) Foreign Application Priority Data
Apr. 7, 2020 (SE) 2050394-2

(51) Int. Cl. H01M 8/2483; H01M 8/0297; H01M 8/1004; H01M 8/2404; H01M 8/2418

(52) U.S. Cl. CPC H01M 8/2483; H01M 8/0297; H01M 8/1004; H01M 8/2404; H01M 8/2418

(57) ABSTRACT

A manufacturing arrangement for a fuel cell stack or at least a unit fuel cell of the fuel cell stack includes at least a pre-arrangement site for arranging a membrane electrode assembly and a bipolar plate in a predefined orientation to each other, wherein the bipolar plate has at least one opening and/or at least one specific contour, and wherein the membrane electrode assembly and the bipolar plate are oriented to each other in such a way that the membrane electrode assembly covers at least one opening in the bipolar plate and/or extends over the bipolar plate in at least one area; wherein the manufacturing arrangement further includes at least one cutting site with a cutting device which is adapted to cut the membrane electrode assembly in a predetermined area so that the membrane electrode assembly has a cut opening, which resembles the at least one opening of the bipolar plate, and/or at least one cut contour, which resembles the at least one contour of the bipolar plate, and/or at least one cut alignment structure for aligning the unit fuel cells in a fuel cell stack, as well as a corresponding manufacturing method.

The present application is a divisional of U.S. application Ser. No. 17/916,830, filed Oct. 4, 2022, which is the U.S. national stage of International App. PCT/SE2021/050307, fled Apr. 6, 2021, which claims priority to Swedish App. SE2050394-2, file Apr. 7, 2020, all of which are incorporated by reference.

### BACKGROUND AND SUMMARY

The present invention relates to a manufacturing arrangement for a fuel cell stack as well as to a method for manufacturing a fuel cell stack, a unit fuel cell and a fuel cell stack, which have been manufactured by means of said arrangement and/or method.

A fuel cell stack usually comprises two monopolar plates between which a plurality of membrane electrode assemblies is arranged, which in turn are separated by bipolar plates. The membrane electrode assembly (MEA) itself comprises at least a cathode, an anode and a membrane therebetween, for reacting hydrogen and oxygen to electric energy and water. For providing the reactants (hydrogen and oxygen) to the respective electrodes, the bipolar plates arranged at both sides of the membrane electrode assembly have a fluid flow field which guides the reactants' fluid flow to the respective electrodes.

Since the reaction in a single membrane electrode assembly typically produces insufficient voltage for operating most applications, a plurality of the membrane electrode assemblies and bipolar plates is stacked and electrically connected in series to achieve a desired voltage. Electrical current is collected from the fuel cell stack and used to drive a load. There are different solutions known for manufacturing a fuel cell stack. For example, in CN 106876756 A, bipolar plates and membrane electrode assemblies are designed as endless tapes, which are arranged to each other. For providing a fuel cell stack the endless tapes are cut to length forming unit fuel cells, and the unit fuel cells are stacked.

The efficiency of the fuel cell stack depends on the flow of reactants across the surfaces of the membrane electrode assembly as well as the integrity of the various contacting and sealing interfaces within individual fuel cells of the fuel cell stack. Such contacting and sealing interfaces include those associated with the transport of fuels, coolants, and effluents within and between the unit fuel cells of the stack. Consequently, proper positional alignment of fuel cell components and assemblies within a fuel cell stack is critical to ensure efficient operation of the fuel cell system.

Additionally, it has to be ensured that in the stack itself, the adjacent bipolar plates are electrically isolated from each other in order to avoid any short circuit. For that usually, the membrane electrode assembly or parts of the membrane electrode assembly are used. However, in case the membrane electrode assembly and the bipolar plate are misaligned, parts of the bipolar plate might be exposed which increases the risk for short circuits as exposed parts of adjacent bipolar plates may come into contact with each other. Consequently, a precise alignment of membrane electrode assembly and bipolar plate is very important for ensuring proper operation of the fuel cell stack.

For aligning and stacking, usually an alignment tool, as for example an alignment framework having at least one guiding element, is used, which ensures a predefined arrangement of the membrane electrode assemblies and bipolar plates during the stacking process. After the desired amount of membrane electrode assemblies and bipolar plates has been stacked, the resulting fuel cell stack is compressed, e.g. screwed together or otherwise bonded, so that the fuel cell stack can be used in the desired application.

For ensuring a proper alignment of the membrane electrode assemblies and the bipolar plates it has been proposed in the state of the art, to provide membrane electrode assembly and/or bipolar plate with alignment features such as recesses into which the guiding elements of the alignment framework may be inserted or incorporated.

The disadvantage of the known alignment is that both membrane electrode assembly and bipolar plate have to be provided with the respective alignment features, which is very costly, and only very narrow tolerances in the manufacture of membrane electrode assemblies and bipolar plates are allowable. Additionally, the stacking process is very time consuming and in case only a single bipolar plate or membrane electrode assembly is not properly aligned, the complete stack has to be dismissed.

It is therefore desirable to provide a manufacturing arrangement and method for manufacturing a fuel cell stack, which allows for a fast, reliable and cost-effective stacking of a fuel cell stack.

The basic idea of an aspect of the present invention is to improve the alignment of a membrane electrode assembly and a bipolar plate by cutting the openings and/or the shape of the membrane electrode assembly and/or alignment structures at the membrane electrode assembly after having arranged or oriented the membrane electrode assembly and the bipolar plate to each other. Thereby, problems arising due to misalignment of the membrane electrode assembly and the bipolar plate, e.g. short circuits, may be avoided.

In the following, a manufacturing arrangement for manufacturing a fuel cell stack with a plurality of stacked unit fuel cells or for manufacturing at least a unit fuel cell of the fuel cell stack is disclosed, wherein the unit fuel cell comprise at least a bipolar plate and a membrane electrode assembly.

In general, the membrane electrode assembly usually has an active area with the electrodes and the membrane (3-layer membrane electrode assembly), and a so called subgasket which encompasses the active area, thereby forming a 5-layer membrane electrode assembly. Additionally, a gas diffusion layer may be arranged between the bipolar plate and the membrane electrode assembly, wherein the gas diffusion layer may be attached to the membrane electrode assembly itself, forming a 7-layer membrane electrode assembly, or to the bipolar plate. Regardless of the exact arrangement or the layer structure, all kind of membrane electrode assemblies are addressed by the phrase “membrane electrode assembly” in this application.

The bipolar plate roughly comprises three main areas: an active area with a flow field for distributing reactant to the respective electrode of the membrane electrode assembly, a distribution area for distributing the reactant to the flow filed and a supply area for supplying the reactant from a main supply channel in the fuel cell stack to the distribution area. It should be further noted that the bipolar plate in this context may be either a cathode plate and/or an anode plate or a bipolar plates assembly comprising both the anode plate and the cathode plate which have been bonded.

The suggested manufacturing arrangement further comprises a plurality of sites, e.g. a pre-arrangement site and a cutting site. In the pre-arrangement site at least one membrane electrode assembly and at least one bipolar plate are arranged in predefined orientation to each other, wherein the at least one bipolar plate has at least one opening and/or at least one specific contour. Further, the membrane electrode assembly and the bipolar plate are oriented in such a way that the membrane electrode assembly covers at least one opening in the bipolar plate and/or extends over the bipolar plate in at least one area.

For providing a unit fuel cell which allows for a fast and precise manufacturing and subsequent stacking of the fuel cells, the manufacturing arrangement further comprises a cutting site with a cutting device for cutting a membrane electrode assembly. By cutting the membrane electrode assembly after the bipolar plate and the membrane electrode assembly have been oriented to each other, it may be ensured that the membrane electrode assembly covers the bipolar plate in all places, thereby avoiding any risks for shorts circuits.

The cutting device further comprises a cutting element, which is adapted to cut the membrane electrode assembly in a predetermined area, so that the membrane electrode assembly has a cut opening, which resembles the opening of the bipolar plate, and/or at least one cut contour, which resembles the contour of the bipolar plate, and/or at least one cut alignment structure for aligning the unit fuel cells.

Consequently, the basic idea of an aspect of the present invention is to improve the alignment of a membrane electrode assembly and a bipolar plate by cutting the openings and/or the shape and/or alignment structures of the membrane electrode assembly after having oriented the membrane electrode assembly and the bipolar plate to each other. Thereby, problems arising due to misalignment of the membrane electrode assembly and the bipolar plate, e.g. short circuits, may be avoided.

Preferably, the part of the membrane electrode assembly which extends over the contour and/or opening of the bipolar plate is the subgasket and/or the gas diffusion layer, which is/are made from material/s which may be easily cut, e.g. from plastic and/or carbon paper. Consequently, it is preferred that the cutting element is adapted to cut the material of the subgasket and/or the gas diffusion layer. The subgasket is usually used for isolating the bipolar plates from each other and resembles the shape of the bipolar plate, so any misalignment of the subgasket may increase the risk of the bipolar plates touching each other, which in turn results in a short circuit which has to be avoided under all circumstances. Even if misalignment of the electrodes does not necessarily result in a short circuit, it reduces the efficiency of the fuel cell stack and has therefore to be avoided.

According to a further preferred embodiment, the cutting element is a cutting punch having a shape which resembles the form of one or more opening(s) in a bipolar plate and/or one or more specific contour(s) of the bipolar plate and/or one or more alignment structures and/or the shape of the bipolar plate as such. The use of a cutting punch allows for a precise and fast cutting of the membrane electrode assembly. Additionally, the cutting punch can be provided in a wide variety of different shapes so that any kind of shape or opening can be cut into the membrane electrode assembly.

According to a further embodiment, the manufacturing arrangement further comprises at least one fastening device for fastening the membrane electrode assembly to the bipolar plate so that a pre-mounted unit fuel cell is provided. The fastening device may be part of the pre-arrangement site or may be located in a separate fastening site. Preferably, the membrane electrode assembly and the bipolar plate, which are received in the receiving unit are fastened to each other, preferably by gluing, welding, particularly ultrasonic welding or laser welding, and/or soldering, before the membrane electrode assembly is cut. For that the fastening device may comprise a gluing unit and/or a welding unit. This allows for a fast and secure fastening process.

By cutting the membrane electrode assembly after having fastened the membrane electrode assembly to the bipolar plate, manufacturing and alignment intolerances may be counterbalanced. The area of the membrane electrode assembly with the predefined shape may be used as cut alignment structure during stacking of the unit fuel cells. Since the shape is made after the bipolar plate and membrane electrode assembly have been fastened, almost automatically a very precise alignment of the unit fuel cells may be achieved.

As mentioned above, besides the cutting of alignment structures, the cutting device may also be used for cutting other structures to the membrane electrode assembly, e.g. required openings for main supply channels of the reactants. With other words, the shape of the membrane electrode assembly which resembles the shape of the bipolar plate is provided after the membrane electrode assembly has been fastened to the bipolar plate. Hence, according to a further preferred embodiment, the membrane electrode assembly which will be fastened to the bipolar plate is a sheet element without any openings and the cutting device is further adapted to cut at least one required opening of the at least one membrane electrode assembly. This allows for a simplified manufacturing process and also for an increase in accuracy as well as for avoiding the risk for short circuits. This is due to the fact that less elaborateness is necessary during the orientation of the membrane electrode assembly to the bipolar plate and/or during the fastening of the membrane electrode assembly to the bipolar plate. The subgasket and/or gas diffusion layer which surrounds the active parts of the membrane electrode assembly may be cut to shape after the fastening process. Additionally, the risk for short circuit may be eliminated as the cutting after the fastening ensures that the membrane electrode assembly, or in fact the subgasket, isolates the bipolar plate in all areas.

According to a further embodiment, the pre-arrangement site of the manufacturing arrangement further comprises a holding unit which is adapted to receive and hold at least one membrane electrode assembly and bipolar plate or a plurality of bipolar plates and membrane electrode assemblies in a pre-arranged orientation, and the cutting device is adapted to cut at least one or a plurality of membrane electrode assemblies. This allows for example for cutting the openings in the membrane electrode assemblies in an aligned subset of unit fuel cells or the complete fuel cell stack, after the unit fuel cells have been aligned by cut alignments structures and a corresponding alignment feature, e.g. a guiding element, such as a guiding rack.

According to a further preferred embodiment, the manufacturing arrangement further comprises at least one handling device for handling the membrane electrode assembly and/or the bipolar plate and/or a pre-mounted unit fuel cell and/or a unit fuel cell in at least one of the site and/or for transferring the membrane electrode assembly and/or the bipolar plate and/or a pre-mounted unit fuel cell and/or a unit fuel cell from one of the sites to another one of the sites.

The phrases “pre-mounted unit fuel cell” and “ready-to-use unit fuel cell” are used to distinguish unit fuel cells, which are ready to use in a fuel cell stack from unit fuel cells which are not yet finalized. Thus, a pre-mounted unit fuel cell might miss required elements, such as openings for reactants or special alignment features for aligning the unit fuel cell into a stack or to unit fuel cells, in which the membrane electrode assembly and the bipolar plate are not fastened to each other. The term “ready-to-use unit fuel cell” however, shall describe a unit fuel cell which is ready to use in a fuel cell stack and comprises all elements, structures, openings and contours as in the final fuel cell stack. In case such a distinguishing is not necessary, the simple phrase “unit fuel cell” refers to both “pre-mounted” and “ready-to-use” unit fuel cells.

Preferably, the manufacturing arrangement has in the pre-arrangement site at least a first manipulation unit for receiving a bipolar plate, and a second manipulation unit for receiving a membrane electrode assembly, wherein the first manipulation unit and the second manipulation unit are adapted to arrange the membrane electrode assembly and the bipolar plate in a predefined orientation to each other.

Further, it is preferred that the second manipulation unit which receives the membrane electrode assembly, and the first manipulation unit, which receives the bipolar plate, are adapted to arrange the bipolar plate on top of the membrane electrode assembly. Preferably, the first manipulation unit is adapted to carefully place the bipolar plate with its theoretical middle point in the center of the second manipulation unit. Thereby, it can be ensured that the active part of the membrane electrode assembly is arranged at the fluid flow field of the bipolar plate.

For avoiding a short circuit, it is further preferred that a plurality of unit fuel cells is first stacked and then the required openings are cut. Therefore, an embodiment is preferred, wherein the cutting device is further adapted to cut a plurality of membrane electrode assemblies.

Moreover, it also advantageous to use a two-step cutting process, wherein first the alignment structures are cut, then the plurality of so called pre-mounted unit fuel cells is aligned by using the alignment structures and finally the required openings are cut for providing a subgroup of a plurality of precisely aligned so called ready-to-use unit fuel cells. These subgroups of ready-to-use unit fuel cells in turn may then be stacked for providing the final fuel cell stack. Of course, it is also possible to cut the required openings in the finally stacked fuel cell stack.

According to a further preferred embodiment, the manufacturing assembly further comprises an alignment and/or stacking site, which is adapted to receive, align and/or stack a plurality of unit fuel cells. Thereby, it is advantageous that the alignment and/or stacking site further comprises alignment features which are adapted to align the plurality of unit fuel cells based on the ate least one cut alignment structure of the membrane electrode assembly. Thereby, it is preferred that the at least one alignment feature of the alignment and stacking site has a complementary shape to the alignment structure of the membrane electrode assembly.

As mentioned above, the predefined shape of the cut membrane electrode assembly resembles the contour of the bipolar plate. Thereby, the predefined shape may be used as alignment structure for both the membrane electrode assembly and the bipolar plate. Additionally, short circuits may be avoided and the overall dimensions of the fuel cell stack may be optimized.

According to a further preferred embodiment, the membrane electrode assembly is cut in an area which is arranged at the outer periphery, preferably at at least one corner, preferably at two diagonally opposite corners, of the pre-mounted fuel cell unit. Thereby, the unit fuel cell may be stacked and/or aligned using a diagonally working arrangement. This ensures a simplified and fast stacking/alignment process, whereby the diagonally opposite corners of the unit fuel cell may be used for stacking/aligning.

Consequently, it is further preferred that the alignment and/or stacking site, which is adapted to receive, align and/or stack the plurality of unit fuel cells comprises guiding elements which are arranged at diagonally opposite corners. As mentioned above, it is advantageous, that the alignment features of the alignment and/or stacking site are further adapted to align the plurality of unit fuel cells based on the cut area of the membrane electrode assembly.

It is further preferred that the alignment and/or stacking site further comprises a first alignment structure and a second alignment structure which are adapted to accommodate a plurality of unit fuel cells. The alignment and stacking site may further comprise a handling unit which is adapted to turn at least one of the unit fuel cells by 180° and arrange the turned unit fuel cell at at least one other, preferably un-turned, unit fuel cell. Thereby a slanted stacking may be avoided. It is even possible to turn every second unit fuel cell.

According to a further preferred embodiment, the sites in the manufacturing arrangement are arranged in a certain manufacturing order, wherein, the pre-arrangement site is arranged upstream of the cutting site, which is in turn arranged upstream of the alignment site. The optional fastening site is preferably arranged downstream of the pre-arrangement site, but upstream of the cutting site. It should be also noted that the sites may not be physically separated from each other, but may be realized as combined sites.

A further aspect of the present invention relates to a method for manufacturing a fuel cell stack comprising the steps of:
Arranging, in a pre-arrangement stage, a bipolar plate and a membrane electrode assembly to each other in a predefined orientation, wherein the bipolar plate has at least one opening and/or at least one specific contour, and wherein the membrane electrode assembly and the bipolar plate are oriented to each other in such a way that the membrane electrode assembly covers at least one opening in the bipolar plate and/or extends over the bipolar plate in at least one area; and
Cutting the membrane electrode assembly in at least one predefined area so that the membrane electrode assembly has a cut opening, which resembles the at least one opening of the bipolar plate, and/or at least one cut contour, which resembles the at least one contour of the bipolar plate, and/or at least one cut alignment structure for aligning the unit fuel cells in a fuel cell stack.

The method may further comprise a fastening step, in a so called fastening stage, wherein the membrane electrode assembly is fastened to the bipolar plate, for providing a pre-mounted unit fuel cell, preferably by gluing, welding and/or soldering. The fastening step is preferably performed after the arranging step, but before the cutting step.

Further steps of the method may comprise:
Providing a bipolar plate, namely a cathode plate, an anode plate or a preassembled bipolar plate assembly;
Providing a preassembled membrane electrode assembly;
Fastening the membrane electrode assembly to the bipolar plate, so that a preassembled unit fuel cell is provided, wherein the membrane electrode assembly extends over a contour of the bipolar plate in at least one area.

According to a further embodiment, the method further comprises the step of aligning the unit fuel cells by means of at least one of the cut structures cut into the membrane electrode assembly of the pre-mounted unit fuel cell.

It should be further noted that the discussed features of the apparatus also apply for the claimed method.

It is further preferred to use a manufacturing arrangement as discussed above, which is adapted to perform the corresponding method steps.

A further aspect of the present invention relates to a read-to use unit fuel cell for a fuel cell stack, wherein the ready-to-use unit fuel cell is manufactured by the above described manufacturing arrangement and/or the above described manufacturing method.

A further aspect of the present invention relates to a fuel cell stack comprising a plurality of unit fuel cells, as mentioned above, which has been manufactured by means of the arrangement and/or by means of the method as mentioned above.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

The figures show:

FIG. 1a-d: schematic illustrations depicting steps of the manufacturing of a unit fuel cell according to a first embodiment;

FIG. 2: a schematic drawing of a cutting device according to a second embodiment; and

FIG. 3a-c: a schematic illustration depicting steps of the manufacturing of a unit fuel cell according to a third embodiment.

### DETAILED DESCRIPTION

In the following same or similar functioning elements are indicated with the same reference numerals.

Further, in the following, the phrases “pre-mounted unit fuel cell” and “ready-to-use unit fuel cell” are used to distinguish unit fuel cells, which are ready to use in a fuel cell stack from unit fuel cells which are not yet finalized. Thus, a pre-mounted unit fuel cell might miss required elements such as openings for reactants or special alignment features for aligning the unit fuel cell into a stack or to unit fuel cells in which the membrane electrode assembly and the bipolar plate are not fastened to each other. The term “ready-to-use unit fuel cell” however, shall describe a unit fuel cell which is ready to use in a fuel cell stack and comprises all elements, structures, openings and contours as in the final fuel cell stack. The simple phrase “unit fuel cell” refers to both “pre-mounted” and “ready-to-use” unit fuel cells. For example, the stacking and aligning of unit fuel cells may be done with ready-to-use unit fuel cells as well as with pre-mounted fuel cells.

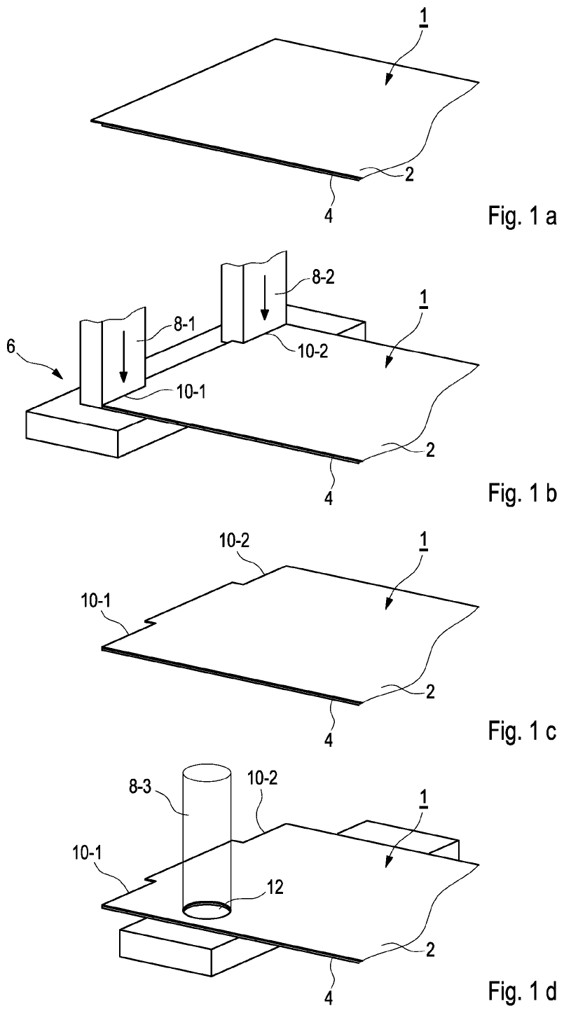

FIG. 1 illustrates schematically the manufacturing steps of a unit fuel cell 1, according to a first embodiments of the invention, which comprises at least a membrane electrode assembly 2 and a bipolar plate 4. Thereby it is to be noted that the membrane electrode assembly 2 comprises at least a membrane, which is sandwiched by two electrodes, (3-layer membrane electrode assembly) and may be surrounded by a subgasket, thereby forming a 5-layer membrane electrode assembly. Additionally, the membrane electrode assembly 2 may also comprise a gas diffusion layer attached to the 5-layer membrane electrode assembly, thereby forming a 7-layer membrane electrode assembly. Of course, other arrangements and more or less layers are also possible. For the sake of simplicity all kind of membrane electrode assemblies are addressed by the phrase membrane electrode assembly 2 in the following.

FIG. 1a depicts a membrane electrode assembly 2 in a pre-arrangement site of a manufacturing arrangement (not shown), which is arranged on top of a bipolar plate 4. Thereby, the membrane electrode assembly 2 and the bipolar plate 4 are oriented to each other and provide a so-called pre-mounted unit fuel cell. As illustrated in FIG. 1a, in the pre-mounted unit fuel cell, the membrane electrode assembly 2 overlaps over the bipolar plate 4 and does not have any openings and/or contours which resemble the shape of the bipolar plate 4. Preferably, the membrane electrode assembly 2 is attached to the bipolar plate 4 by any suitable fastening procedure, e.g. gluing, welding, particularly ultrasonic welding, soldering, etc.

Thereby it should be noted that there is a plurality of fastening possibilities of the membrane electrode assembly 2 to the bipolar plate 4. For example, in case a 5-layer membrane electrode assembly 2 is used, the gas diffusion layer is a separate element and may be fastened to the bipolar plate 4 before the membrane electrode assembly is fastened to the bipolar plate 4. Alternatively, it is also possible that the gas diffusion layer is fastened to the 5-layer membrane electrode assembly and then the 7-layer membrane electrode assembly is fastened to the bipolar plate 4. Further it is possible to fasten the 5-layer membrane electrode assembly 2 to the bipolar plate 4 and arrange and fasten the gas diffusion layer afterwards e.g. during stacking.

It goes without saying, that the step of fasting the membrane electrode assembly 2 to the bipolar plate 4 may also be performed after the membrane electrode assembly 2 has been cut into shape.

In the next step, as illustrated in FIG. 1b, the membrane electrode assembly 2 and the bipolar plate 4 are inserted into a cutting device 6. The cutting device may be part of a cutting site of the manufacturing arrangement. Of course, it is also possible that the above described orientation step is performed in the cutting device 6 itself, whereby a combined site of pre-arrangement site and cutting site is used. For that the cutting device 6 may comprise e.g. at least one holding unit (not illustrated), which is adapted to receive the membrane electrode assembly 2 and the bipolar plate 4 and orient them to each other. Of course, the holding unit may also be adapted to receive a pre-mounted unit fuel cell as such.

Further, the cutting device 6 comprises at least one cutting punch 8, which is adapted to cut the membrane electrode assembly 2 in a predefined area. In the illustrated embodiment of FIG. 1b, there are two cutting punch elements 8-1, 8-2, which are adapted to cut the edges 10-1, 10-2 of the membrane electrode assembly 2. Thereby, every pre-mounted unit fuel 1 is provided with the same edges 10-1, 10-2 which may be used for aligning the unit fuel cells 1 in a subsequent, stacking step. Since the cut edges 10-1, 10-2 are identical for each unit-fuel cell 1, it is possible to improve the aligning accuracy and thereby the operation of the fuel cell. A pre-mounted unit fuel cell 1 with only the alignment structures, namely the cut edges 10-1, 10-2 is shown in FIG. 1c. These alignment structures may interact with correspondingly but complementary shaped alignment features during the stacking of the fuel cell stack.

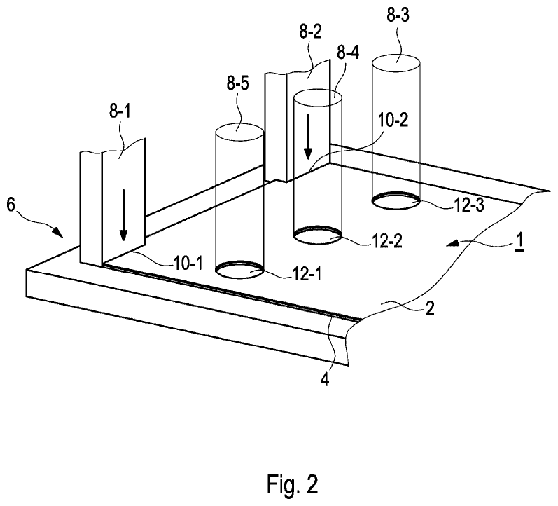

Besides the cutting of alignment structures, namely the cut edges 10-1, 10-2, it is also possible to cut openings 12 for the reactants and coolants by using a correspondingly shaped cutting punch element 8-3, as illustrated in FIG. 1d. The cutting of the openings 12 may be performed in a subsequent step to the cutting of the alignment structures 10, but it is also possible that all structures, openings 12, alignment structures 10 etc., are cut with a single correspondingly shaped cutting element 8, as is illustrated in FIG. 2.

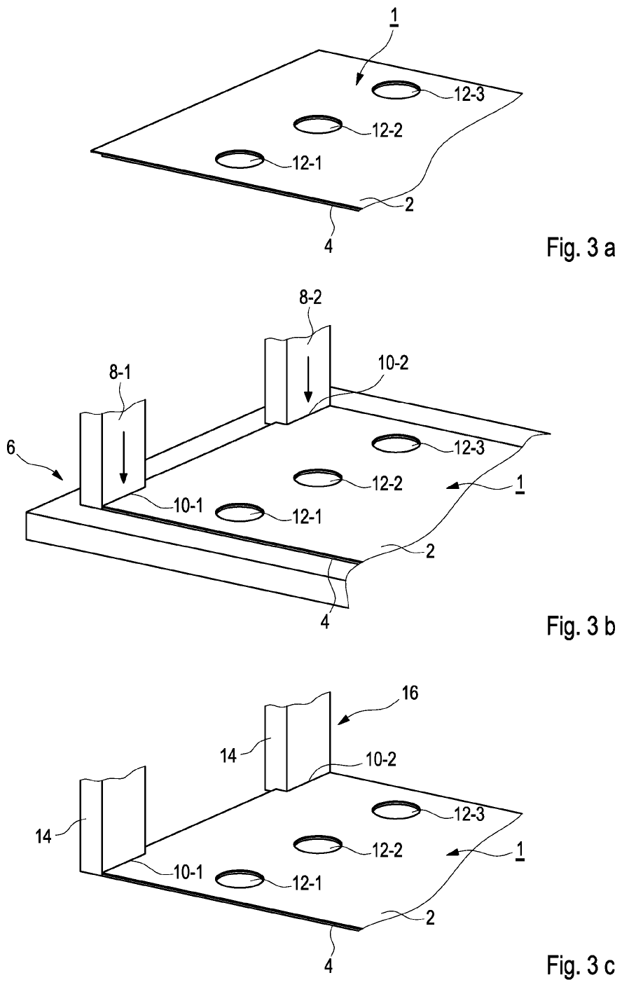

Further, it is also possible that the cutting of the openings 12 has already been performed before the membrane electrode assembly 2 and the bipolar plate 4 are oriented to each other, or the membrane electrode assembly 2 already has pre-manufactured openings, as is illustrated in FIGS. 3a-c. In the illustrated embodiment, the cutting of the edges may be used for providing identical alignment structures 10-1, 10-2 at the unit fuel cells, which fit to corresponding alignment features 14 (see FIG. 3c) so that the unit fuel cells can be precisely stacked.

However, by cutting both, the openings 12 and the alignment structures 10, the risk for short circuit or misalignment of the membrane electrode assembly 2 to bipolar plate 4 may be reduced, as the cutting of the membrane electrode assembly 2 after the orientation of the membrane electrode assembly 2 to the bipolar plate 4 ensures that the membrane electrode assembly 2 covers the bipolar plate 4 in all places and thereby isolates two adjacent bipolar plates 4. An accidental exposure of the bipolar plate 4 by a misaligned membrane electrode assembly 2 can be avoided.

In a further not illustrated embodiment, a subset of pre-mounted unit fuel cells are first aligned and fastened to each other and only after having aligned the subset of pre-mounted unit fuel cells, the openings in the membrane electrode assembly are cut.

In the illustrated embodiment of FIG. 3, all structures, e.g. openings, alignment structures contours are performed before the then ready-to-use unit fuel cell is transferred to an alignment site (see FIG. 3c) comprising an alignment unit 16 as schematically illustrated in FIG. 3c. The alignment unit 16 has alignments features 14, which have a corresponding shape to the alignment structures 10-1, 10-2, so that a very precise alignment of the unit fuel cells is possible.

In summary, by cutting the membrane electrode assembly 2 into shape after having the membrane electrode assembly 2 arranged or preferably attached to the bipolar plate 4, a very precise alignment of the unit fuel cells is possible. Additionally, any risk for short circuits is avoided as it is ensured that the membrane electrode assembly covers the bipolar plate in all places so that the bipolar plate 4 is nowhere exposed and can come into contact with an adjacent bipolar plate 4.

### REFERENCE NUMERALS

1 unit fuel cell
2 membrane electrode assembly
4 bipolar plate
6 cutting device
8 cutting punch
10 cute edges (alignment structure)
12 openings
14 alignment features
16 alignment unit

1. A method for manufacturing a fuel cell stack with a plurality of stacked unit fuel cells or at least a unit fuel cell of a fuel cell stack comprising the steps of:
orienting a bipolar plate and a membrane electrode assembly to each other in a predefined orientation, wherein the bipolar plate has at least one opening and/or at least one alignment structure, and wherein the membrane electrode assembly and the bipolar plate are oriented to each other in such a way that the membrane electrode assembly covers the at least one opening in the bipolar plate and/or or the at least one alignment structure and/or extends over the bipolar plate in at least one area;
fastening the membrane electrode assembly to the bipolar plate; and
cutting the membrane electrode assembly in at least one predefined area so that the membrane electrode assembly has a at least one cut opening, which resembles the at least one opening of the bipolar plate, and/or at least one cut alignment structure, which resembles the at least one alignment structure of the bipolar plate, and/or at least one cut alignment structure, which extends over a periphery of the bipolar plate, for aligning the unit fuel cells by means of the membrane electrode assembly in a fuel cell stack.

2. The method according to claim 1, wherein the step of fastening the membrane electrode assembly to the bipolar plate is performed after the cutting step.

3. The method according to claim 1, further comprising the step of aligning the unit fuel cells by using at least one of the cut alignment structures of the membrane electrode assembly.

4. The method according to claim 3, wherein the aligning step further comprises turning of at least one unit fuel cell by 180°.

5. The method according to claim 1, comprising using a manufacturing arrangement for manufacturing a fuel cell stack with a plurality of stacked unit fuel cells or at least a unit fuel cell of the fuel cell stack, wherein the unit fuel cell comprise at least a bipolar plate and a membrane electrode assembly, and the manufacturing arrangement comprising at least:
a receiving unit for receiving a membrane electrode assembly and at least a bipolar plate with at least one opening and/or at least one alignment structure, and wherein the receiving unit of the cutting device is further adapted to orient the membrane electrode assembly and the bipolar plate in such a way that the membrane electrode assembly covers the at least one opening in the bipolar plate and/or the at least one alignment structure and/or extends over the bipolar plate in at least one area; and
a cutting device for cutting a membrane electrode assembly comprising a cutting element which is adapted to cut the membrane electrode assembly in a predetermined area, so that the membrane electrode assembly has at least one cut opening, which resembles the at least one opening of the bipolar plate, and/or at least one cut alignment structure, which resembles the at least one alignment structure of the bipolar plate, and/or at least one cut alignment structure, which extends over a periphery of the bipolar plate for aligning the unit fuel cells by means of the membrane electrode assembly.

6. A unit fuel cell for a fuel cell stack, wherein the unit fuel cell is manufactured by the method according to claim 1.

7. A fuel cell stack comprising a plurality of unit fuel cells according to claim 6.
